(19) United States
(12) Patent Application Publication
(10) Pub. No.: US 2010/0218974 A1
(43) Pub. Date: Sep. 2, 2010

(54) Multi-layer insulated conductor with crosslinked outer layer

(75) Inventor: Ashok K. Mehan, Union City, CA (US)

Correspondence Address: Tyco Electronics Corporation, 309 Constitution Drive, Mail Stop R34/2A, Menlo Park, CA, 94025, US

(73) Assignee: Tyco Electronics Corporation, Berwyn, PA (US)

(21) Appl. No.: 12/380,533

(22) Filed: Feb. 27, 2009

(51) Int. Cl. H01B 7/00; B29C 47/88; B01J 19/08

(52) U.S. Cl. 174/120 SR; 264/211.12; 264/473

(57) ABSTRACT

An insulated conductor and method for making it are disclosed. The insulated conductor includes an elongate conductor and a two-layer insulation system. The two-layer insulation system has a first insulating layer including an aromatic thermoplastic material adjacent with the elongate conductor. The first insulating layer has a thickness along its length of less than about 0.051 mm (0.002 inch). The insulation system also includes a second insulating layer including a crosslinked fluoropolymer adjacent the first insulating layer. The volume of the first insulating layer is less than about 26% of the total volume of the insulation system.

### RELATED APPLICATIONS

This application is related to U.S. application Ser. No. ______ also entitled “Multi-Layered Insulated Conductor with Crosslinked Outer Layer” (attorney docket no. E-AD-00020-US) and U.S. application Ser. No. ______ entitled “Method for Extrusion of Multi-Layer Coated Elongate Member” (attorney docket no. E-AD-00025-US) both filed on even date herewith, the disclosures of which are incorporated herein by reference.

### FIELD

This application is directed to insulated electrical conductors and more particularly to a multi-layer insulated conductor having a crosslinked outer layer overlying an inner aromatic polymer layer.

### BACKGROUND

Electrically insulated wires are often used in environments in which the physical, mechanical, electrical and thermal properties of the insulation are put to the test by extreme conditions. In many cases, the material used for the insulation has desirable attributes to achieve good performance in one or more these properties, but at the cost of compromising one or more of the other desired properties, which can negatively impact efforts to achieve an overall balance of desirable and commercially attractive properties. Multi-layer insulation systems can be useful in trying to achieve this balance of properties.

As aerospace applications drive toward increasingly higher performance standards, size and weight form a significant part of overall design requirements of wires and cables used in those applications. It would be desirable to decrease the total insulation thickness, particularly in primary wires (i.e., those which are used to form a cable or bundle) in order to reduce both weight and size of the wire. By reducing the diameter of the primary wire, corresponding bundles of those wires—along with any outer metallic braids and/or jackets used as a protective covering for them—can also be of an overall smaller diameter, and thus lighter. Alternatively, or in combination, smaller and lighter primary wires can allow an increased number of wires to be packed into the same space as fewer, heavier wires without having to make significant changes to routing, sealing and/or cable restraining hardware systems.

High performance fluoropolymers are a widely used and accepted class of materials for use in aircraft wire insulation systems. However, reducing the wall thickness of these materials to gain weight savings ordinarily results in worsening mechanical performance and an increase in arc tracking resistance, which would be expected to also lead to unacceptable electrical performance.

Fault current arcing, or “arc tracking”, is particularly undesirable in aircraft wiring for safety reasons. Insulation faults typically occur in wiring due to pre-existing defects, initiate arcing fire, and can destroy an entire area of the cable or device to which it is connected. Often, leakage currents with an initially high impedance aided by the presence of electrolytically acting liquids in the vicinity lead to wet arc tracking, subsequently decrease in impedance over the course of time and, finally, result in high-energy short-circuit arcing. Alternately, dry arc tracking can also occur and can cause sudden low-impedance shunts. Either can result in significant failure.

These and other drawbacks are found in current insulated conductors.

### SUMMARY

According to an exemplary embodiment of the invention, an insulated conductor is disclosed. The insulated conductor includes an elongate conductor and a two-layer insulation system having an extruded first insulating layer comprising an aromatic thermoplastic material adjacent the elongate conductor, the first insulating layer having a thickness along its length of less than about 0.051 mm (0.002 inch) and an extruded second insulating layer comprising a crosslinked fluoropolymer adjacent the first insulating layer. The volume of the first insulating layer is less than about 26% of the total volume of the insulation system.

In one preferred embodiment, the conductor is a stranded conductor between 20 AWG and 26 AWG (i.e., having a diameter in the range of about 0.46 mm (0.0180 inch) and about 1.04 mm (0.041 inch)), the first insulating layer comprises polyetheretherketone and has a thickness in the range of between about 0.013 mm (0.0005 inch) and 0.051 mm (0.002 inch), the second insulating layer comprises crosslinked poly(ethylene tetrafluoroethylene) and the insulation system has a thickness in the range of between about 0.15 mm (0.006 inch) and 0.18 mm (0.007 inch).

According to another exemplary embodiment of the invention, a method for manufacturing an insulated conductor is provided. The method includes the sequential steps of providing an elongate conductor, melt extruding an aromatic thermoplastic material onto an outer surface of the elongate conductor to create a first insulating layer having a substantially uniform thickness along its length of less than 0.051 mm (0.002 inch), melt extruding a compound including a fluoropolymer and a crosslinking agent onto an outer surface of the first insulating layer to create a second insulating layer overlying and in contact with the first insulating layer to provide the insulation system having a total thickness in the range of about 0.15 mm (0.006 inch) to 0.18 mm (0.007 inch) in which a volume of the first insulating layer is less than about 26% by volume of the total volume of the insulating system. The method further includes crosslinking the second insulating layer.

An advantage of certain exemplary embodiments of the invention includes that an insulated conductor is provided that has a durable, low weight insulation system.

Another advantage of certain exemplary embodiments of the invention includes that the insulated conductor unexpectedly achieves reduced insulation weight and size while maintaining or improving both mechanical performance and arc-tracking resistance to meet acceptable electrical performance standards.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a perspective view of an insulated conductor in accordance with an exemplary embodiment of the invention with partial removal of the insulating layers.

FIG. 2 illustrates a cross-sectional view of the insulated conductor of FIG. 1 along line 2-2.

Where like parts appear in more than one drawing, it has been attempted to use like reference numerals for clarity.

### DETAILED DESCRIPTION OF EXEMPLARY EMBODIMENTS

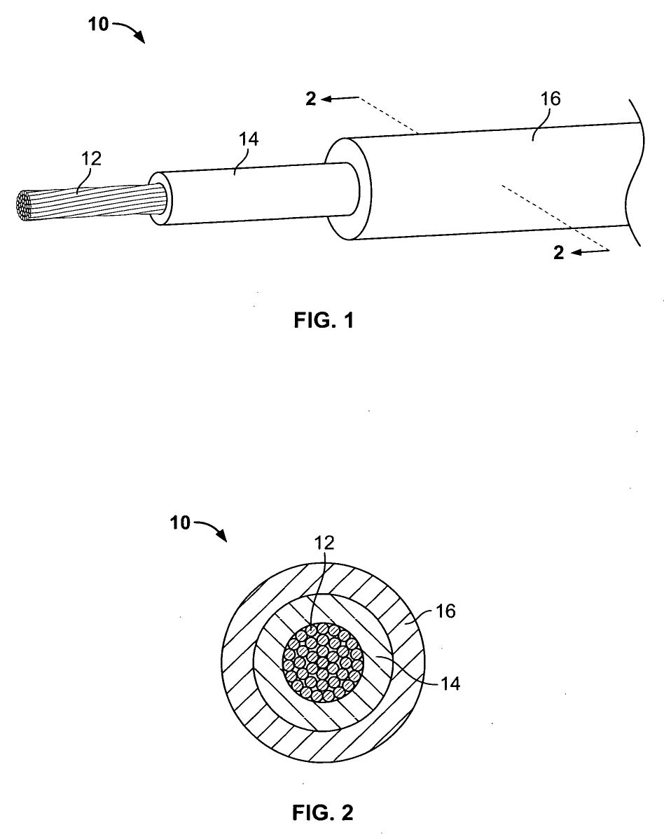

Turning to FIG. 1, exemplary embodiments of the invention are directed to an insulated conductor 10 that includes an elongate conductor 12 and an insulating system having a first insulating layer 14 and a second insulating layer 16.

The elongate conductor 12 may be a wire of any suitable gauge and may be solid or stranded (i.e., made up of many smaller wires twisted together). FIG. 2 illustrates a cross-sectional view of the insulated conductor shown in FIG. 1 in which the elongate conductor 12 is a stranded conductor, which is preferred for applications in aircraft or other settings in which the conductor will be subject to vibration. The conductor 12 is generally copper or another metal, such as copper alloy or aluminum. If pure copper is used, it may be coated with tin, silver, nickel or other metal to reduce oxidation and improve solderability. Stranded conductors may be of the unilay, concentric or other type. The conductor preferably has a diameter in the range from between about 0.404 mm (0.0159 inch) to about 0.81 mm (0.032 inch) for solid conductors, or a diameter in the range from between about 0.46 mm (0.0180 inch) to about 1.04 mm (0.041 inch) for stranded conductors. These diameters correspond to standard dimensions for 20 AWG to 26 AWG wires.

The first insulating layer 14 overlies and is adjacent the elongate conductor 12. The first insulating layer 14 is comprised of an extruded aromatic thermoplastic material so as to provide a first insulating layer 14 that has a substantially uniform thickness along its length, which cannot adequately be achieved by tape-wrapping techniques. The first insulating layer 14 may be applied by any suitable extrusion technique, such as tube extrusion or pressure extrusion, for example. As will be appreciated, tube extrusion refers to a technique in which the material being extruded is contacted to the surface to which it is being applied outside the extruder die, while pressure extrusion refers to a technique in which the material being extruded is contacted to the surface to which it is being applied while it is still within the extruder die.

The material selected for the first insulating layer 14, also referred to as the inner or core layer, is selected to have a high tensile modulus (as measured according to ASTM D638) both at room temperature and at elevated temperature. In one embodiment, the first insulating material has a tensile modulus of at least 1241 MPa (180,000 psi) at 25° C. Furthermore, the material is generally selected to resist bonding with the underlying conductor 12; bonding increases the difficulty of subsequent stripping. Exemplary aromatic materials having these characteristics include polyetheretherketone (PEEK), polyetherketoneketone (PEKK), polyetherketone (PEK), polyimide (PI), polyetherimide (PEI), polyamide-imide (PAI), polysulfone (PS) and polyethersulfone (PES), as well as miscible blends of these materials. Preferably, the first insulating layer includes PEEK. The first insulating layer 14 is preferably not crosslinked and preferably should not contain any crosslinking agents, although other additives as are typically used in insulation applications, such as pigments and/or antioxidants may optionally be provided.

The second insulating layer 16 overlies and is in contact with the first insulating layer 14. Like the first insulating layer, the second insulating layer 16 is also extruded to provide a substantially uniform thickness along its length, which results in a smooth outer surface. Like the first insulating layer 14, the second insulating layer 16 may also be applied by tube or pressure extruding techniques. The second insulating layer 16 comprises a fluoropolymer. However, the second insulating layer 16 may also be a polyamide, a polyester or a polyolefin, or a miscible blend of these materials. In one embodiment, the second insulating layer includes a fluoropolymer selected from the group consisting of poly(ethylene tetrafluoroethylene) (ETFE), poly(ethylene chlorotrifluoroethylene) (ECTFE), polyvinylidene fluoride (PVDF), polytetrafluoroethylene; tetrafluoroethylene-hexafluoropropylene-vinylidene fluoride terpolymer (THV), and miscible blends of these materials, any of which may provide a particularly tough, smooth outer layer. Other suitable fluoropolymers include perfluoroalkoxy polymers (PFA) and fluorinated ethylene propylene polymers (FEP). In one embodiment, the polymeric material selected for the second insulating layer 16 has a tensile modulus of at least 414 MPa (60,000 psi) at 25° C. In a preferred embodiment, the fluoropolymer of the second insulating layer is ETFE.

Unlike the first insulating layer 14 which is preferably not crosslinked, the second insulating layer 16 is crosslinked. The crosslinking preferably occurs by irradiation, although chemical crosslinking, for example, may also be used. The level of crosslinking in the second insulating layer 16 is such that the resulting insulated conductor 10 can meet a pre-determined level of arc tracking resistance or a predetermined level of dielectric strength following exposure to a high temperature under load, and preferably both.

The first insulating layer 14 has a substantially uniform thickness less than about 0.051 mm (0.002 inch), typically in the range from about 0.013 mm (0.0005 inch) to about 0.051 mm (0.002 inch), and more typically in the range from about 0.025 mm (0.001 inch) to about 0.051 mm (0.002 inch). The second insulating layer 16 has a substantially uniform thickness such that the combined thickness of the first and second insulating layers is in the range of about 0.15 mm (0.006 inch) to about 0.18 mm (0.007 inch). The volume of the aromatic polymer of the first insulating layer is about 26% or less than the total volume of the insulation system.

In addition to the polymeric constituents of the first and second insulating layers, each of the layers may include any conventional constituents for wire insulation such as antioxidants, UV stabilizers, pigments or other coloring or opacifying agents, and/or flame retardants. The second insulating layer, but preferably not the first insulating layer, may also include crosslinking agents to achieve crosslinking during the irradiation step. Any additives, including crosslinking agents, may together make up less than about 10% by weight of the layer, and preferably are about 7% or less by weight.

### EXAMPLES

The invention is further described with respect to the following examples, which are presented by way of illustration and not of limitation.

A 20 AWG concentrically stranded conductor having an outer diameter of 0.942 mm (0.0371 inch) of soft annealed copper was tin plated. PEEK, obtained as PEEK 450G from Victrex Corporation, was dried at 160° C. in an air circulating oven for 24 hours immediately prior to extrusion. The PEEK was tube extruded over the conductor using an extruder barrel length to inside diameter (L/D) ratio of 24:1 to an average thickness of 0.048 mm (0.0019 inch).

A layer of ETFE was then extruded over the PEEK. In one example, the ETFE was provided by combining a first low melt-flow rate, high molecular weight ethylene-tetrafluoroethylene copolymer (obtained from Asahi Glass Corp. under the trade designation Fluon C-55A and stated as having a melt flow rate in the range of 4.0 to 6.7 grams per 10 minutes as measured in accordance with ASTM D1238) and a second high melt-flow rate, low molecular weight ethylene-tetrafluoroethylene copolymer (obtained from Daikin Industries under the trade designation Neoflon EP 7000 and stated as having a melt flow rate in the range of 15 to 25 grams per 10 minutes as measured in accordance with ASTM D1238) in a 2:1 ratio by weight. This blend together made up 93% by weight of the second insulating layer. The balance was additives including 0.75% by weight of the phenolic antioxidant Irganox 1010 (obtained from Ciba Geigy Corp), 1.25% by weight of inorganic fillers and pigments (obtained from DuPont) and 5.0% by weight of the crosslinking agent triallyl isocyanurate (“TAIC”) (obtained from Nippon Kasei Chemical Corporation).

The second insulating layer ingredients (other than the crosslinking agent) were tumble blended for 40 minutes using a rotary blender after which the compound was fed into a gravimetric feeder for a 27 mm, 40:1 L/D, co-rotating intermeshing Leistritz twin screw extruder. The TAIC was introduced into the extruder barrel about two thirds of the way downstream, then the complete second insulating layer compound was strand pelletized.

The pelletized second insulating layer material was dried at 60° C. in an air circulating oven for 8 hours, following which it was tube extruded over the PEEK layer in a one pass set-up in accordance with known dual layer extrusion techniques using a second 31.8 mm (1.25 inch) extruder in-line with the PEEK layer extruder to an average wall thickness of 0.084 mm (0.0033 inch). The L/D ratio for the ETFE extruder was 24:1.

The dual-layer insulated wire was subsequently exposed to electron beam radiation on a commercial 1 MeV electron beam to expose the wire to different levels of irradiation ranging between 5 and 32 Mrads. Immediately following irradiation, the insulated wire was annealed at 160° C. for 30 minutes.

Additional samples were prepared in a similar manner, but in which the Neoflon and Fluon ETFE components were mixed in a 1:1 weight ratio at a slightly higher overall weight percentage of the second insulating layer (93.3% by weight), with a corresponding weight reduction in pigments (1% by weight). Still more samples were prepared in which the only ETFE in the second insulating layer was the Neoflon (at approximately 93.3% by total weight).

The thickness of the inner (PEEK) layer, total insulation thickness (PEEK and ETFE layers), and the level of irradiation were independently varied in creating numerous different batches of sample conductor specimens for further study.

The formed specimens were then studied to determine their ability to pass industry standard arc-tracking manufacturing requirements (conducted according to Boeing Specification Support Standard BSS-7324 for purposes of meeting Boeing Manufacturing Standard BMS 13-48K using applicable procedures for a 20 AWG tin plated wire with a 0.20 mm (0.008 inch) crosslinked ETFE insulation and incorporated here by reference) as a function of inner layer thickness, volume percent of the inner layer with respect to the total dual-layer insulation system, and the level of irradiation. Only groups of samples in which at least 90% of the insulated conductors for a given set of variables were undamaged by the arc-tracking test were considered passing for purposes of arc-track resistance testing. (The requirement set forth in the test standard is that 89% must be undamaged.)

All of the formed strands were also studied for mechanical performance by subjecting the coated wires to the Proof of Crosslinking Test (CPT), the full details of which are set forth in Mil Std 2223, method 4003 entitled “Crosslink Proof (Accelerated Aging)” which is herein incorporated by reference.

Briefly, this test is meant to establish whether a wire has a predetermined level of dielectric strength remaining after exposure to high temperature for some period of time while under a mechanical load. High performance wires are expected to withstand deformation under load at elevated temperatures even beyond the melting point of the insulation for short-term exposures, from a few minutes to a few hours.

The deforming force is applied as a tensile force to each end of an insulated conductor that is draped over a mandrel so that the segment of the insulation system between the conductor and mandrel is under compression while the conductor is under tension.

A load of 0.68 kg (1.5 pounds) was applied to each end of 20 AWG samples of coated conductors in accordance with exemplary embodiments and were hung over a mandrel with an outside diameter of 12.7 mm (0.5 inch). The specimens, so hung on the mandrel, were then conditioned in an air-circulating oven at 300±3° C. for 1 hour, while others were hung for 7 hours. The velocity of air past each specimen (measured at room temperature) was not less than 30 meters per minute (100 feet per minute). After conditioning, the oven was shut off, the door opened, and the specimen allowed to cool in the oven for at least 1 hour. When cool, the specimen was freed from tension, removed from the mandrel, straightened and wrapped 180 degrees, at its center point, again over a 12.7 mm (0.5 inch) mandrel, but with the portion of the insulation that had been against the mandrel during heating now on the outside of the bend. The specimen was then immersed for four hours in a 5% salt solution at room temperature with the ends positioned to stay outside of the salt solution. At the end of the conditioning period, a 2500 Volt rms, 50 Hertz AC voltage was applied between the conductor and an electrode in the salt solution at a uniform rate of 250 to 500 volts per second. This potential was maintained for at least five minutes. The leakage current limit of the test equipment was set at 20 milliampere. Any evidence of leakage current in excess of 20 milliamperes was recorded as a failure.

An insulation strength was calculated as a figure of merit using an empirically determined formula based on the results of the CPT for purposes of correlating the thickness of each of the two insulating layers and the level of crosslinking with mechanical performance. The insulation strength was calculated as

$$( 3 * I ) + \frac{O * R}{32 Mrads}$$

where I=thickness of first insulating layer (in thousandths of an inch); 0=thickness of second insulating layer (in thousandths of an inch); and R=level of irradiation (in Mrads) used to crosslink the second insulating layer.

This particular figure of merit was selected because the aromatic polymer has a higher modulus than the crosslinked fluoropolymer and because the modulus of the crosslinked fluoropolymer layer depends upon the level of crosslinking, which in turn depends upon the level of irradiation and amount of crosslinking agent present.

It was determined from these experiments that a thin, dual-layer insulation system in which the first insulating layer is PEEK and the second insulating layer is primarily crosslinked ETFE could be achieved that meets a low weight standard while unexpectedly maintaining both of suitable mechanical and electrical properties, such as arc-tracking resistance. In doing so, it was determined that a combination of (1) the aromatic PEEK layer having a thickness of about 0.051 mm (0.002 inch) or less, (2) less than about 26% by volume of the aromatic PEEK in the insulating system, (3) irradiation less than or equal to 13 Mrads to produce the crosslinked fluoropolymer ETFE second insulating layer (in which the crosslinking agent was present in the experiments in an amount of about 5% by weight), and (4) an insulation strength of at least 3.5 could be used to produce an insulated conductor having a total insulation weight that is 0.30 kg per 305 meter (0.65 lbs per 1000 feet) or less for a 20 AWG conductor and which can still pass industry standard tests for both arc tracking resistance and CPT mechanical performance (i.e. dielectric strength). More particularly with respect to insulation strength, it was determined than an insulation strength of 3.5 or more would meet one hour CPT requirements, while an insulation strength of 7.5 or more would meet seven hour CPT requirements.

In one embodiment, the first insulating layer has a thickness in the range of 0.025 mm to 0.051 mm (0.001 inch to 0.002 inch) and the second insulating layer has a level of crosslinking corresponding to exposure to irradiation in the range of 5 to 13 Mrads. In another embodiment, the first insulating layer has a thickness in the range of 0.018 mm to 0.051 mm (0.0007 inch to 0.002 inch) and the second insulating layer has a level of crosslinking corresponding to exposure to irradiation in the range of 9 to 13 Mrads.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An insulated conductor comprising:
an elongate conductor; and
a two-layer insulation system having
an extruded first insulating layer comprising an aromatic thermoplastic material adjacent the elongate conductor, the first insulating layer having a thickness along its length of less than about 0.051 mm (0.002 inch); and
an extruded second insulating layer comprising a crosslinked fluoropolymer adjacent the first insulating layer,
a volume of the first insulating layer being less than about 26% of a total volume of the insulation system.

2. The insulated conductor of claim 1, wherein the second insulating layer has a level of crosslinking sufficient for the insulated conductor to meet a pre-determined level of arc-tracking resistance.

3. The insulated conductor of claim 1, wherein the second insulating layer has a level of crosslinking sufficient for the insulated conductor to meet a predetermined level of dielectric strength following exposure to a predetermined temperature under a predetermined load for a predetermined period of time.

4. The insulated conductor of claim 1, wherein the first insulating layer has a thickness in the range of 0.013 mm (0.0005 inch) to 0.051 mm (0.002 inch).

5. The insulated conductor of claim 1, wherein the total thickness of the insulating system is in the range of about 0.15 mm (0.006 inch) to about 0.18 mm (0.007 inch).

6. The insulated conductor of claim 1, wherein the first insulating layer comprises an aromatic thermoplastic selected from the group consisting of polyetheretherketone, polyetherketoneketone, polyetherketone, polyimide, polyetherimide, polyamide-imide, polysulfone, polyethersulfone, and miscible blends thereof.

7. The insulated conductor of claim 1, wherein the first insulating layer comprises polyetheretherketone.

8. The insulated conductor of claim 1, wherein the second insulating layer comprises a crosslinked fluoropolymer selected from the group consisting of poly(ethylene tetrafluoroethylene), poly(ethylene chlorotrifluoroethylene), polyvinylidene fluoride, polytetrafluoroethylene, tetrafluoroethylene-hexafluoropropylene-vinylidene fluoride terpolymer, perfluoroalkoxy polymers, fluorinated ethylene propylene polymers and miscible blends thereof.

9. The insulated conductor of claim 8, wherein the second insulating layer comprises crosslinked poly(ethylene tetrafluoroethylene).

10. The insulated conductor of claim 1, wherein the first insulating layer has a thickness in the range of 0.013 mm (0.0005 inch) to 0.051 mm (0.002 inch) and the insulation system has a total thickness in the range of about 0.15 mm (0.006 inch) to about 0.18 mm (0.007 inch).

11. The insulated conductor of claim 1, wherein the first insulating layer comprises polyetheretherketone and wherein the second insulating layer comprises crosslinked poly(ethylene tetrafluoroethylene).

12. The insulated conductor of claim 1, wherein the elongate conductor is a stranded conductor having a diameter less than about 1.04 mm (0.041 inch).

13. An insulated conductor comprising
an elongate stranded conductor having a diameter in the range of about 0.46 mm (0.0180 inch) to about 1.04 mm (0.041 inch); and
a two-layer insulation system having
an extruded first insulating layer comprising polyetheretherketone adjacent the elongate conductor, the first insulating layer having a substantially uniform thickness along its length in the range of about 0.013 mm (0.0005 inch) to 0.051 mm (0.002 inch); and
an extruded second insulating layer comprising crosslinked poly(ethylene tetrafluoroethylene) adjacent the first insulating layer, the second insulating layer having a substantially uniform thickness along its length,
a volume of the first insulating layer being less than 26% of the total volume of the first and second insulating layers and the total thickness of the insulation system being in the range of about 0.15 mm (0.006 inch) to about 0.18 mm (0.007 inch).

14. The insulated conductor of claim 13, wherein the first insulating layer has a thickness in the range of 0.025 mm (0.001 inch) to 0.051 mm (0.002 inch) and wherein the second insulating layer comprises at least about 90% by weight poly(ethylene tetrafluoroethylene) and at least about 5% by weight of a crosslinking agent and wherein the second insulating layer has a level of crosslinking corresponding to exposure to irradiation in the range of 5 to 13 Mrads.

15. The insulated conductor of claim 13, wherein the first insulating layer has a thickness in the range of 0.018 mm (0.0007 inch) to 0.051 mm (0.002 inch) and wherein the second insulating layer comprises at least about 90% by weight poly(ethylene tetrafluoroethylene) and at least about 5% by weight of a crosslinking agent and wherein the second insulating layer has a level of crosslinking corresponding to exposure to irradiation in the range of 9 to 13 Mrads.

16. The insulated conductor of claim 13, wherein the second insulating layer has a level of crosslinking sufficient such that the insulated conductor meets both of (a) a pre-determined level of arc-tracking resistance and (b) a predetermined level of dielectric strength following exposure to a predetermined temperature under a predetermined load for a predetermined period of time.

17. A method for manufacturing an insulated conductor comprising:
providing an elongate conductor; thereafter
melt extruding an aromatic thermoplastic material onto an outer surface of the elongate conductor to create a first insulating layer having a substantially uniform thickness along its length of less than 0.051 mm (0.002 inch); thereafter
melt extruding a compound comprising a fluoropolymer and a crosslinking agent onto an outer surface of the first insulating layer to create a second insulating layer overlying and in contact with the first insulating layer to provide an insulation system having a total thickness in the range of about 0.15 mm (0.006 inch) to 0.18 mm (0.007 inch), wherein a volume of the first insulating layer is less than about 26% by volume of the total volume of the insulating system; and thereafter
crosslinking the second insulating layer.

18. The method of claim 17, wherein the aromatic thermoplastic material layer comprises polyetheretherketone and wherein the fluoropolymer comprises poly(ethylene tetrafluoroethylene).

19. The method of claim 17, wherein the step of melt extruding the aromatic thermoplastic material comprises creating a first insulating layer having a thickness in the range of 0.001 inch to 0.051 mm (0.002 inch).

20. The method of claim 17, comprising crosslinking the second layer by irradiation to a level of crosslinking sufficient such that the insulated conductor meets both of (a) a pre-determined level of arc-tracking resistance and (b) a predetermined level of dielectric strength following exposure to a predetermined temperature under a predetermined load for a predetermined period of time.
